(19) United States
(12) Patent Application Publication
(10) Pub. No.: US 2011/0083897 A1
(43) Pub. Date: Apr. 14, 2011

(54) ELECTRIC POWER TERMINAL FEED-THROUGH

(76) Inventors: Dieter Paterek, Vroomshoop (NL); Mark Yiu Kong Tang, Hong Kong (CN); Glen Kwok, Hong Kong (CN); Gerald Ng, Hong Kong (CN); Tim Murphy, Middletown, OH (US); Ck Leung, Hong Kong (CN)

(21) Appl. No.: 12/992,968

(22) PCT Filed: May 19, 2009
(86) PCT No.: PCT/US09/44476

§ 371 Date: Dec. 9, 2010

Related U.S. Application Data
(60) Provisional application No. 61/054,183, filed on May 19, 2008.

(51) Int. Cl. H02G 3/18

(52) U.S. Cl. 174/667

(57) ABSTRACT

A power terminal feed-through includes a housing, at least one current conducting pin and a sealing glass hermetically sealing the at least one current conducting pin to the housing. The at least one current conducting pin defines a peripheral indentation in the surface of the current conducting pin. The sealing glass fills in the peripheral indentation when fused to both the current conducting pin and housing.

### CROSS-REFERENCE TO RELATED APPLICATIONS

This application claims the benefit of U.S. Provisional Application No. 61/054,183, filed on May 19, 2008. The entire disclosure of the above application is incorporated herein by reference.

### FIELD

The present disclosure relates to electric power terminal feed-throughs, and more particularly to electric power terminal feed-throughs that include one or more current conducting pins.

### BACKGROUND

Hermetically-sealed electric power terminal feed-throughs provide an airtight electrical connection for use in conjunction with hermetically sealed devices. Leakage into or from the hermetically sealed devices by way of the feed-throughs is prohibited. Such electric power terminal feed-throughs generally comprise a housing through which extend one or more current conducting pins, and a sealing material that hermetically seals the pins to housing.

The current conducting pins used in the electric power terminal feed-throughs as electric feeds are generally manufactured by a drawing process. The pins are commonly drawn from low carbon steel, 446 stainless steel, or a copper-cored steel wire, and generally have good corrosion resistance and thermal expansion properties. However, as an artifact of the manufacturing process, imperfections in the form of micro-cracks at the surface of the pins can result. Micro-cracks in the surface of the pins are costly to eliminate and difficult to detect on a piece-by-piece basis in a high-volume manufacturing environment. The micro-cracks can adversely impact the integrity of the power terminal feed-through's hermetic seal, increasing manufacturing scrap rates and reducing the long-term reliability of the feed-through.

For example, a current conducting pin 11 assembled into an electric power terminal feed-through 10 may have a micro-crack 12 that results from the drawing manufacturing process. As shown in FIG. 1, the micro-crack 12 extends along a longitudinal axis X of the current conducting pin 11. The micro-crack 12 is generally too small to enable a sealing material 15 to flow into and fill the micro-crack 12 during assembly of the feed-through. Thus, when the sealing material 15 is fused to the current conducting pin 11 and housing 13 of the electric power terminal feed-through 10, a gap in the sealing material 15 can result at the location of the micro-crack 12. In such as case, therefore, an open path between a first chamber 14 and a second chamber 16 at opposite ends of the current conducting pin 11 creates a leakage path that prevents the necessary hermetic seal from being achieved. As a consequence, the entire electric terminal feed-through 10 has to be scrapped.

### SUMMARY

In one form, an electric power terminal feed-through includes a housing, at least one current conducting pin, and a sealing glass. The housing defines an opening therethrough. The at least one current conducting pin extends through the opening and includes a peripheral indentation in its exterior surface that is located within the opening. The indentation has a depth of approximately 31 μm to approximately 250 μm. The sealing glass substantially fills the peripheral indentation and the opening and is fused to both the at least one current conducting pin and the housing to provide a seal between the pin and the housing.

In another form, an electric power terminal feed-through includes a housing, at least one current conducting pin, and a sealing glass. The housing defines an opening therethrough. The at least one current conducting pin extends through the opening and defines an outer surface and two peripheral notches. The outer surface includes a micro-crack that extends in a direction along a longitudinal axis of the current conducting pin. The peripheral notches are located within the opening and have a depth of approximately 31 to 100 μm. The peripheral notches are spaced apart at a distance of approximately 3 mm in a direction along the longitudinal axis of the current conducting pin. The sealing glass substantially fills the peripheral notches and the opening and is fused to both the at least one current conducting pin and the housing to provide a seal between the at least one current conducting pin and the housing.

In still another form, an electric power terminal feed-through includes a housing, at least one current conducting pin and a sealing glass. The housing defines an opening therethrough. The at least one current conducting pin extends through the opening and defines an outer surface and a peripheral indentation. The outer surface includes a micro-crack that extends in a direction along a longitudinal axis of the current conducting pin. The peripheral indentation is located within the opening and intersects with the micro-crack. The peripheral indentation has a depth of approximately 150 μm or less and a width of approximately 3 mm in a direction along the longitudinal axis of the current conducting pin. The sealing glass substantially fills the peripheral indentation and the opening and is fused to both the at least one current conducting pin and the housing to provide a seal between the at least one current conducting pin and the housing.

This section provides a general summary of the disclosure, and is not a comprehensive disclosure of its full scope or all of its features.

### DRAWINGS

The present invention will become more fully understood from the detailed description and the accompanying drawings, wherein:

FIG. 1 is a schematic cross-sectional view of a prior art electric power terminal feed-through;

FIG. 2 is a top view of an electric power terminal feed-through in accordance with teachings of the present disclosure;

FIG. 3 is a cross-sectional view of an electric power terminal feed-through taken along line A-A of FIG. 2;

FIG. 4 is an enlarged view of portion B of FIG. 3;

FIG. 5 is a top view of a current conducting pin used in an electric power terminal feed-through in accordance with a first embodiment of the present disclosure;

FIG. 6 is a schematic view of a current conducting pin and a sealing material, showing the connection therebetween;

FIGS. 7A and 7B show a partial cross-sectional view and an enlarged image of a portion of a current conducting pin of the present disclosure, showing the relationship between a micro-crack and a peripheral indentation;

FIG. 8 is a top view of a current conducting pin in accordance with a second embodiment of the present disclosure;

FIG. 9A is a top view of a current conducting pin in accordance with a third embodiment of the present disclosure;

FIG. 9B is a side view of a current conducting pin of FIG. 9A;

FIG. 10A is a top view of a current conducting pin in accordance with a fourth embodiment of the present disclosure; and

FIG. 10B is a side view of a current conducting pin of FIG. 10A.

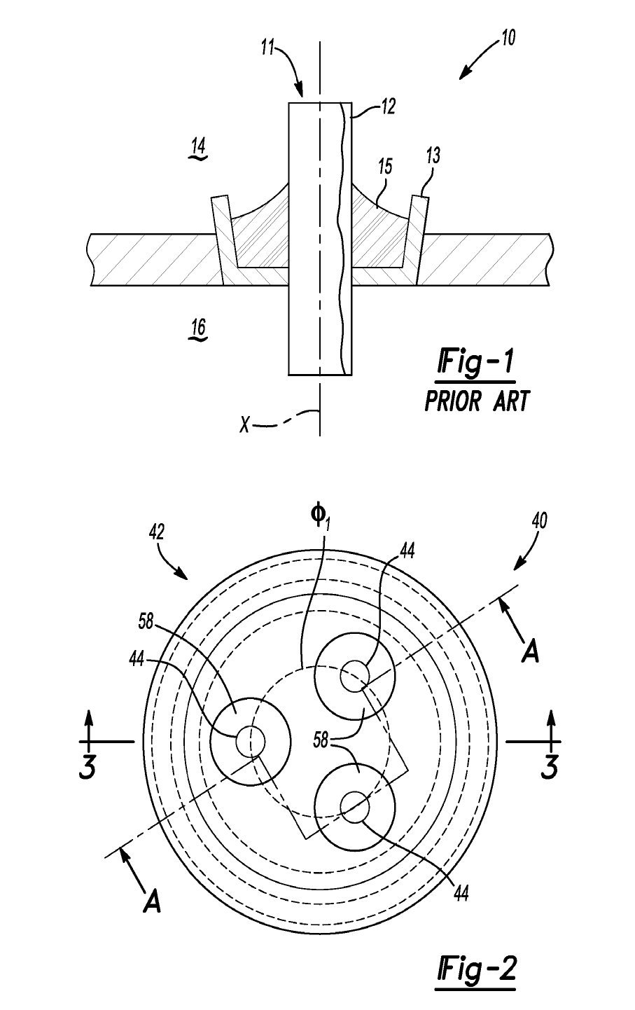

Corresponding reference numerals indicate corresponding parts throughout the several views of the drawings.

### DETAILED DESCRIPTION

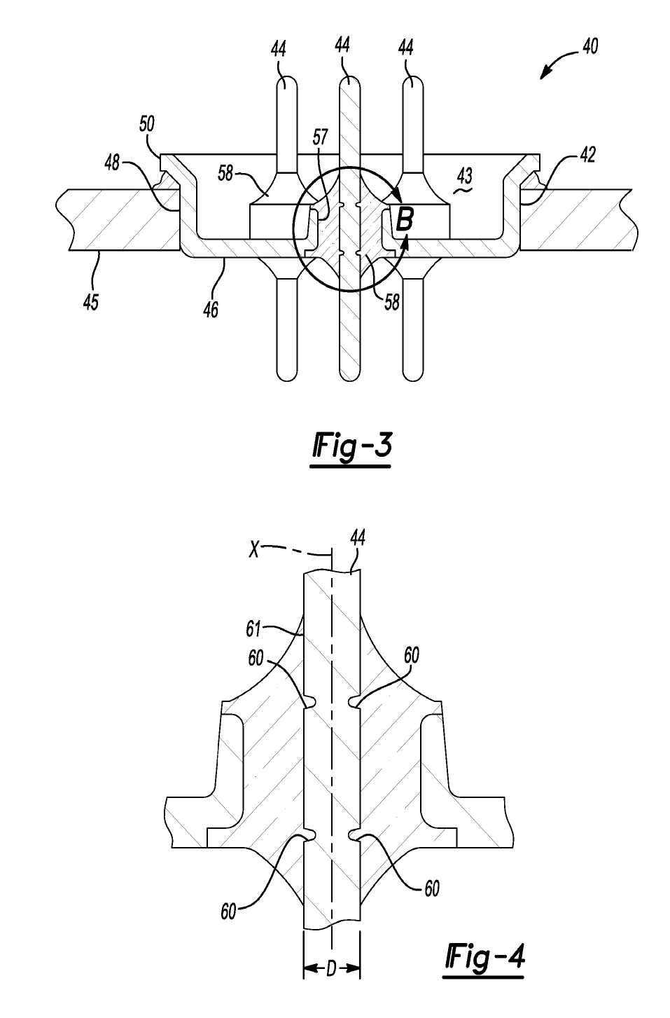

Referring to FIGS. 2 and 3, an electric power terminal feed-through 40 includes a metal housing 42, and a plurality of current conducting pins 44 extending through the metal housing 42. While three current conducting pins 44 are shown in FIGS. 2 and 3, it is understood and appreciated that any number of current conducting pins 44 (including only one current conducting pin) can be formed as necessary or desired.

The placement of the current conducting pins 44 defines a pin circle diameter φ₁, which is the dimension of the circle passing through the centers of each of the current conducting pins 44 and centered on a longitudinal axis of the power terminal feed-through 40. The current conducting pins 44 may be made from low carbon steel, stainless steel, or a copper-cored steel wire.

The metal housing 42 is cup-shaped and defines a receiving space 43. The metal housing 42 includes a bottom wall 46, a cylindrical sidewall 48 connected to and disposed around the bottom wall 46, and an annular lip 50 extending from an end of the cylindrical sidewall 48. The electric terminal feed-through 40 may be mounted to a shell 45 of a hermetically sealed device by positioning the electric terminal feed-through 40 in an opening of the shell 45 and by welding the metal housing 42 to the shell 45.

The bottom wall 46 includes a plurality of openings 57 through which the current conducting pins 44 extend from a first side of the housing 42 to a second side of the housing 42.

A dielectric sealing material 58 fills the openings 57 and surrounds the current conducting pins 44, fusing the current conducting pins 44 to the housing 42. The sealing material 58 electrically insulates the current conducting pins 44 from the housing 42 and hermetically seals the current conducting pins 44 to the housing. The sealing material 58 may be a glass that provides good sealing, adhesion and corrosion resistance.

It is understood and appreciated that when the housing 42 does not have a bottom wall, the inner peripheral surface of the cylindrical sidewall 48 may define the opening through which the current conducting pin extends. Therefore, the sealing material fills in the opening and provides a seal between the current conducting pins 44 and the inner peripheral surface of the cylindrical sidewall 48.

### First Embodiment

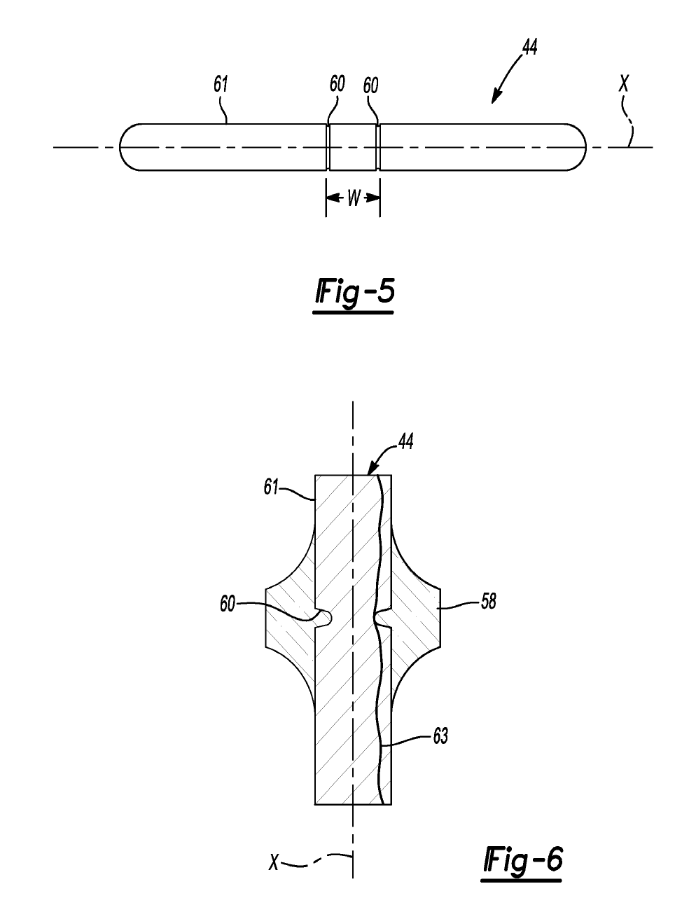

Referring to FIGS. 4 and 5, the current conducting pins 44 may include at least one indentation in an outer surface. The indentation may take a form of a groove, a notch, a recess, or other profiles. In the first embodiment, the current conducting pins 44 have two peripheral notches 60 in an outer surface 61. The current conducting pins have rounded ends. The peripheral notches 60 are formed in a sealing area where the sealing material 58 is fused and in an area directly surrounded by the cylindrical sidewall 48 of the metal housing 42. The peripheral notches 60 are spaced apart along a longitudinal direction X of the current conducting pins 44. The peripheral notches 60 are formed around the diameter of the current conducting pins 44, each defining a circle. The peripheral notches 60 may be formed by rolling and each have a depth d in the range of approximately 31 μm to approximately 188 μm. The diameter D of the current conducting pin 44 is in the range of 2.276 to 2.286 mm.

Therefore, the ratio of notch depth over the diameter of the pin (d/D) is in the range of approximately 0.0136 to approximately 0.0826. The current conducting pins 44 have proven to be more satisfactory when the depth of the peripheral notches 60 is in the range of approximately 31 μm to approximately 100 μm.

The peripheral notches 60 are spaced apart at a distance W along a length of the current conducting pin 44. The distance is equal to or less than 3 mm. The length of the pin is approximately 26.97 mm. Therefore, a ratio of the distance of the peripheral notches 60 over the length of the current conducting pins 44 is approximately 0.111.

Referring to FIG. 6, the advantage of using a peripheral notch to interrupt a potential leakage path is now explained in more detail below. Only one peripheral notch 60 is shown for clarity. The current conducting pins 44 may be made of steel wires by a drawing process which may result in one or more micro-cracks 63 at or near the outer surface 61 of one or more of the current conducting pins 44. Drawing is metalworking process that involves pulling a material through a die by means of a tensile force applied on an exit side of the die. The drawn steel wire, which is later formed into current conducting pins 44, may as a result of the drawing process have a micro-crack 63 at or near its outer surface 61. The micro-crack 63 may extend along the longitudinal direction X of the current conducting pins 44 a sufficient length beyond a sealing area onto which a sealing material 58 is applied. Due to the dimensions of the micro-crack 63 and the viscosity of the sealing material 58, the sealing material 58 may not flow to completely fill the micro-crack 63 when the sealing material 58 fills the space around the current conducting pin 44 at fusing temperatures. Consequently, the micro-crack 63 has the potential to create a leak path and affect the long-term hermetic integrity of a power terminal feed-through.

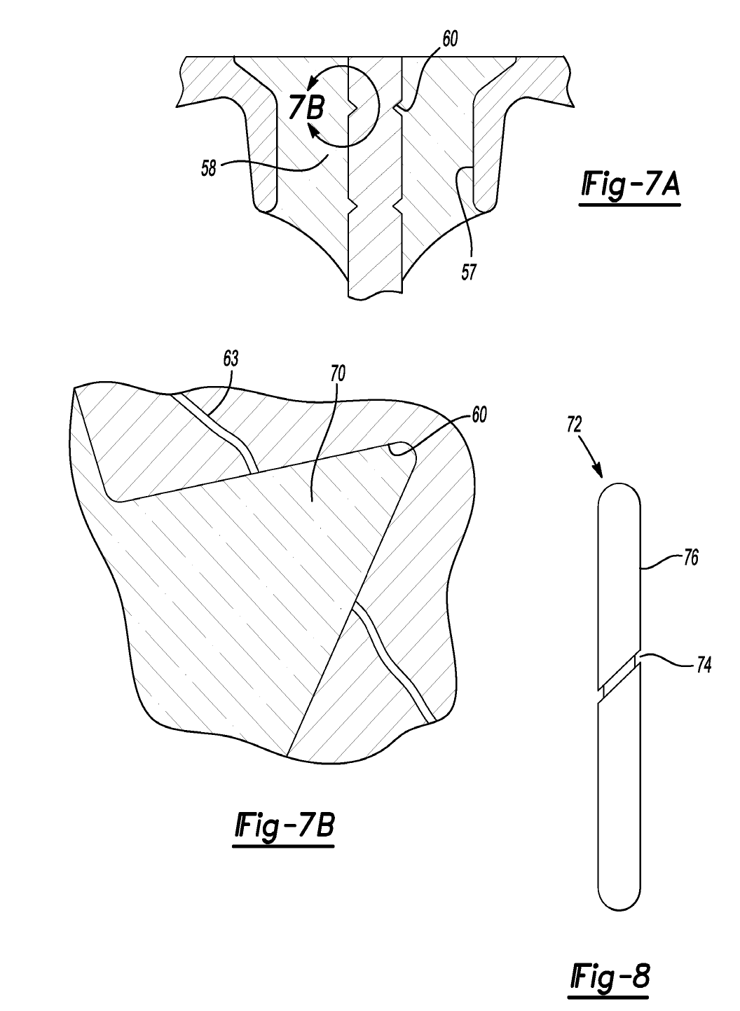

Referring to FIGS. 7A and 7B, in accordance with the present disclosure, a peripheral notch 60 is formed on the current conducting pin 44. A power terminal feed-through with a notched current conducting pin 44 can more reliably maintain long-term hermetic integrity even in the presence of micro-cracks 63. When the peripheral notch 60 is formed on the outer surface of the current conducting pin 44, the sealing material 58 may easily flow into the peripheral notch 60 and fill in the peripheral notch 60 at a fusing temperature. After the sealing material 58 is cooled, a protrusion 70 is formed in the peripheral notch 60 to fill in at least a portion of the micro-crack 63 and interrupt any potential leak path through the hermetic seal.

Tests, including a high pressure helium test, a standard pressure helium test, and a nitrogen gas bubble test (i.e., a leak test for gas-containing enclosures), which were conducted on feed-throughs constructed in accordance with of the present disclosure, have shown reduced failures and improved reliability of the hermetic seal when compared with prior art power terminal feed-throughs. Table 1 shows the results of tests of both a power terminal feed-through of the present disclosure (test item A) and a prior art power terminal feed-through (test item B). Both test items A and B include current-conducting pins that were previously rejected as being defective for having micro-cracks to likely cause leakage in a feed-through. Some of the defective pins are machined to form two peripheral notches 60 in the exterior surface to interrupt possible leakage path(s) and are incorporated in the power terminal feed-throughs in test item A. Some of the defective pins are not subject to further machining process or treatment and are incorporated in power terminal feed-throughs in test item B. The power terminal feed-throughs of the present disclosure that were tested include current conducting pins having two, spaced-apart peripheral notches 60, each notch having a depth in the range of approximately 31 μm to approximately 100 μm.

TABLE 1

| | Test Item | |
|---|---|---|
| | A | B |
| Quantity | 30 pcs | 30 pcs |
| Notch Depth | 0.031~0.1 mm | N/A |
| | Average: 0.0517 mm | |
| Diameter of Pin | 2.276~2.287 mm | 2.272~2.288 mm |
| | average: 2.282 mm | average: 2.279 mm |
| Nitrogen Gas | failure rate: 3/30 = 10% | failure rate: 11/30 = 36.7% |
| Bubble Test | | |
| Micro-Crack | Avg 89 μm | Avg 106 μm |
| Length (after | Min 51 μm | Min 40 μm |
| section | Max 168 μm | Max 305 μm |
| analysis) | | |

As shown by the test results, the power terminal feed-throughs having the notched pins demonstrate a significant reduction in the failure rate over the power terminal feed-throughs without notched pins. Therefore, a reasonable conclusion may be drawn that, despite the presence of micro-cracks on the current conducting pins, the peripheral notches improve the hermetic seal between the sealing material and the current conducting pins.

Table 2 shows test results similar to those in Table 1. Similarly, test items A and B include current-conducting pins that were previously rejected as having micro-cracks to likely cause leakage in a power terminal feed-through. Some of the defective pins are machined to form two peripheral notches 60 in the exterior surface and are incorporated in the power terminal feed-throughs in test item A. Some of the defective pins are not subject to further machining process or treatment and are incorporated in power terminal feed-throughs in test item B. In Table 2, however, the range of depths of the peripheral notches of the current conducting pins is greater, approximately 103 μm to approximately 188 μm.

TABLE 2

| | Test item | |
|---|---|---|
| | A | B |
| Quantity | 30 pcs | 30 pcs |
| Notch Depth | 0.103~0.188 mm | Without |
| Diameter of | 2.279~2.288 mm | 2.276~2.285 mm |
| Pin | | |
| Nitrogen Gas | failure rate: 4/30 = 13.33% | failure rate: 11/30 = 36.7% |
| Bubble Test | | |
| Micro-Crack | Avg 76 μm | Avg 84 μm |
| Length | Min 49 μm | Min 43 μm |
| (after section | Max 130 μm | Max 250 μm |
| analysis) | | |

From the results shown in Table 2, it is reasonable to conclude that increasing the depth of the peripheral notches is not necessarily more effective in interrupting the leakage paths.

### Second Embodiment

Referring to FIG. 8, a current conducting pin 72 according to a second embodiment of the present disclosure may define only one notch 74 on an outer surface 76 of the current conducting pin 72 and in a sealing area to which a sealing material is fused. In addition, the perimeter of the notch 74 may encircle the current conducting pin relative to its longitudinal axis at an angle other than 90°. The notch 74 can effectively interrupt a potential leakage path if the notch 74 defines a closed path around the pin (i.e., where the starting point of the notch 62 coincides with the ending point of the notch 62).

### Third Embodiment

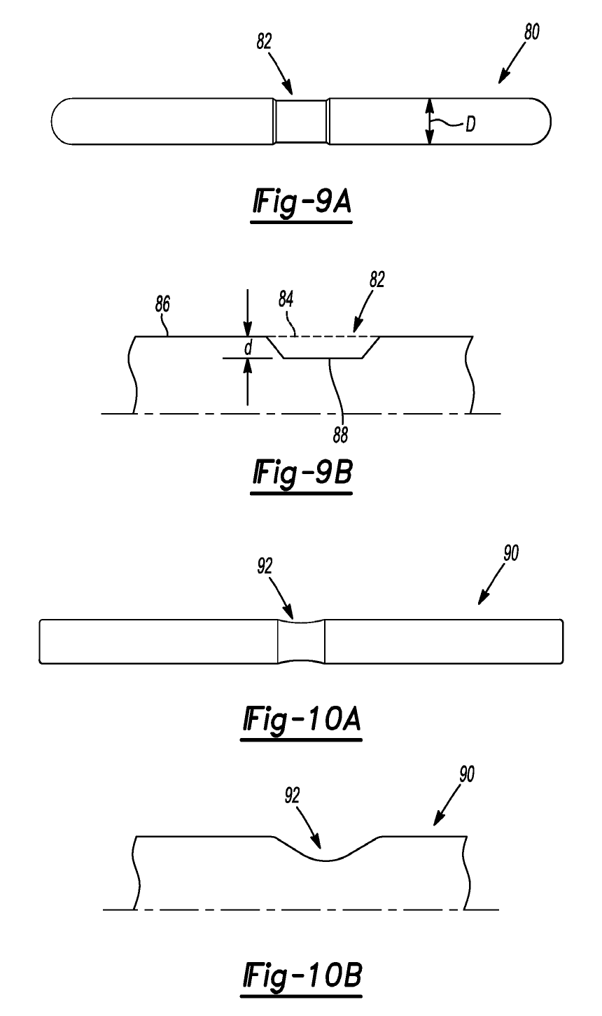

Referring to FIGS. 9A and 9B, a current conducting pin 80 according to a third embodiment of the present disclosure defines only one indentation. The indentation takes the form of a wide peripheral groove 82. The wide peripheral groove 82 can be formed by grinding or rolling or other suitable machining or forging operations. The peripheral groove 82 may have an open end 84 adjacent to the outer surface 86 and a bottom end 88 opposing the open end 84. The open end 84 and the bottom end 88 define a depth d.

The open end 84 is wider than the bottom end 88 so that the sealing material 58 can more easily flow into the peripheral groove 82. The peripheral groove 82 is located in the opening 56 of the bottom wall 46 and in a sealing area of the pin 80 where the sealing material 58 is fused.

When the diameter D of the current conducting pin 80 is in a range of 2.276 mm to 2.287 mm and the length of the current conducting pin is approximately 26.97 mm, the micro-crack length may be in the range of 51 μm to 168 μm. The peripheral groove 82 is formed to have a depth d equal to or less than 250 μm to effectively disrupt and reduce the leak path. The groove depth equal to or less than 150 μm has proved to be more satisfactory. The groove width is approximately 3 mm. Therefore, the ratio of the groove depth over the pin diameter (d/D) may be equal to or less than 0.009, preferably less than 0.006.

It is understood and appreciated that the shape and size of the peripheral indentation (including but not limited to, a notch, a groove, and a recess, for example) may vary depending on applications as long as the sealing material can flow into the peripheral indentation at a fusing temperature.

The increased width of the peripheral groove 82 allows for a protrusion larger than that of the first embodiment to be formed in the peripheral groove 82 to effectively interrupt the leak path. For example, bubble tests have demonstrated that feed-throughs of this embodiment have a lower failure rate than feed-throughs having pins without any peripheral grooves.

In Table 3, Group 1 includes 93,014 feed-throughs including current conducting pins having peripheral grooves of this embodiment, whereas Group 2 includes 92,170 feed-throughs including current conducting pins without any peripheral grooves. The feed-throughs of Group 1 and Group 2 are subject to a bubble test.

As shown, 1 out of 93,014 feed-throughs in Group 1 fails the bubble test and 15 out of 92170 feed-throughs in Group 2 fail the bubble test. The failure rate of the feed-throughs in Group 1 is 11 PPM (parts per million), which is lower than the failure rate of 141 PPM of the feed-throughs in Group 2.

TABLE 3

| | | | Number of | |
|---|---|---|---|---|
| | | Number of | feed-through | |
| | Feed-throughs | feed-throughs | having | Failure rate |
| Group | having pins | tested (pcs) | leakage | (PPM) |
| 1 | with peripheral | 93014 | 1 | 11 |
| | groove | | | |
| 2 | Without | 92170 | 13 | 141 |
| | peripheral | | | |
| | groove | | | |

Analysis of the failed feed-throughs shows that leakage of the feed-throughs is attributable to surface micro-cracks on the pins. The lower failure rate of the feed-throughs that have peripheral grooves indicates that the peripheral grooves are effective in interrupting the leakage path and reducing the failure rate.

### Fourth Embodiment

Referring to FIGS. 10A and 10B, the current conducting pin 90 according to a fourth embodiment of the present disclosure may include an indentation that takes the form of a peripheral groove 92. The peripheral groove 92 has a rounded profile in contrast to the trapezoidal profile as shown in FIG. 9B. The peripheral groove 92 may have a ratio of a groove depth over a pin diameter (d/D) similar to that in FIGS. 9A and 9B. The peripheral groove 92 is formed by rolling.

The current conducting pins 44, 82, 90 of the present disclosure allow for a hermetic seal to be formed between the current conducting pins 44, 82, 90 and the glass material even though a micro-crack may be present along a length of the surface of the current conducting pins 44, 82, 90. The pin design of the present disclosure gives flexibility in suppliers of the current conducting pins to manufacture the current conducting pins from raw wire material. Moreover, the pin design of the present disclosure eliminates the need to sort wire or pins with a cracking condition by extensive tests. The pin design of the present disclosure also reduces a failure rate of feed-throughs that include the current conducting pins of the present disclosure without costly annealing. Therefore, costs for manufacturing the current conducting pins of the present disclosure can be reduced.

This description is merely exemplary in nature and, thus, variations that do not depart from the gist of the disclosure are intended to be included within the scope of the disclosure. Further areas of applicability of the present invention will become apparent from the detailed description provided hereinafter. It should be understood that the description and specific examples, while indicating the preferred embodiment(s) of the invention, are intended for purposes of illustration only and are not intended to limit the scope of this disclosure.

What is claimed is:

1. An electric power terminal feed-through comprising:
a housing defining an opening therethrough;
at least one current conducting pin extending through the opening and including a peripheral indentation in its exterior surface, the indentation being located within the opening and having a depth of approximately 31 μm to approximately 250 μm; and
a sealing glass substantially filling the peripheral indentation and the opening and fused to both the at least one current conducting pin and the housing to provide a seal between the pin and the housing.

2. The electric power terminal feed-through of claim 1, wherein the at least one current conducting pin defines two peripheral notches that are spaced apart along a longitudinal direction of the current conducting pin.

3. The electric power terminal feed-through of claim 2, wherein distance between the peripheral notches is approximately 3 mm.

4. The electric power terminal feed-through of claim 2, wherein the depth of the peripheral notches is in a range from approximately 31 μm to approximately 188 μm.

5. The electric power terminal feed-through of claim 2, wherein the depth of the peripheral notches is in a range from approximately 31 μm to approximately 100 μm.

6. The electric power terminal feed-through of claim 2, wherein a ratio of the depth of the peripheral notches over a diameter of the current conducting pin is from approximately 0.0135 to approximately 0.0826.

7. The electric power terminal feed-through of claim 1, wherein the peripheral indentation defines a width along a longitudinal direction of the current conducting pin, the width being approximately 3 mm.

8. The electric power terminal feed-through of claim 7, wherein the peripheral indentation defines a depth along a radial direction of the current conducting pin, the depth being approximately 150 μm.

9. The electric power terminal feed-through of claim 8, wherein a ratio of the depth of the peripheral indentation over a diameter of the current conducting pin is equal to or less than approximately 0.006.

10. The electric power terminal feed-through of claim 1, wherein the current conducting pin defines only one indentation in the form of a rolled groove having a width of approximately of 3.0 mm.

11. The electric power terminal feed-through of claim 1, wherein the current conducting pin defines a micro-crack extending along a longitudinal direction of the current conducting pin, and the peripheral indentation intersects the micro-crack.

12. The electric power terminal feed-through of claim 12, wherein the sealing material includes a protrusion formed in the peripheral indentation to interrupt the micro-crack.

13. An electric power terminal feed-through comprising:
a housing defining an opening therethrough;
at least one current conducting pin extending through the opening and defining an outer surface and two peripheral notches, and wherein a micro-crack is formed in the outer surface of the pin and extends in a direction along a longitudinal axis of the pin, the peripheral notches being located within the opening and having a depth of approximately 31 μm to approximately 100 μm, the peripheral notches being spaced apart at a distance of approximately 3 mm along the longitudinal axis of the pin; and
a sealing glass substantially filling the peripheral notches and the opening and fused to both the at least one current conducting pin and the housing to provide a seal between the at least one current conducting pin and the housing.

14. An electric power terminal feed-through comprising:
a housing defining an opening therethrough;
at least one current conducting pin extending through the opening and defining an outer surface and a peripheral indentation, and wherein there is a micro-crack formed in the outer surface of the pin that extends in a direction along a longitudinal axis of the pin, the peripheral indentation being located within the opening and intersecting the micro-crack, the peripheral indentation having a depth of approximately 150 μm or less and a width of approximately 3 mm as measured in a direction along the longitudinal axis of the current conducting pin; and
a sealing glass substantially filling the peripheral indentation and the opening and fused to both the at least one current conducting pin and the housing to provide a seal between the at least one current conducting pin and the housing.
